(19) United States
(12) Patent Application Publication
(10) Pub. No.: US 2019/0001812 A1
(43) Pub. Date: Jan. 3, 2019

(54) PRE-CONSUMPTION FUEL ANALYTICS SYSTEM

(71) Applicant: Buddy Moore, Ardmore, OK (US)

(72) Inventor: Buddy Moore, Ardmore, OK (US)

(21) Appl. No.: 14/948,045

(22) Filed: Nov. 20, 2015

Related U.S. Application Data
(60) Provisional application No. 62/082,319, filed on Nov. 20, 2014.

(51) Int. Cl. B60K 15/04; B60K 15/03; G01S 19/13; G01F 15/06; G01F 15/18

(52) U.S. Cl. CPC B60K 15/04; B60K 15/0409; B60K 15/03; G01S 19/13; B60K 2015/03217; G01F 15/18; B60K 2015/0458; B60K 2015/03361; G01F 15/063

(57) ABSTRACT

The present disclosure relates generally to a fuel monitoring system for vehicles. More specifically, an embodiment of the system includes a hollow tube insertable into a filler tube of a fuel reservoir. The hollow tube has a first end defining an opening for receiving a fuel nozzle and a cap connectable to the first end. The system also includes a sensor that produces a signal representative of an amount of fuel flowing through the hollow tube.

### FIELD OF THE INVENTION

The present disclosure relates generally to a fuel monitoring system for vehicles and can be used to monitor many various liquids for many various equipment types.

### BACKGROUND

Each year millions of commercial vehicles, such as semi-tractor-trailers, tractor-trailers, semis, big rigs, semi-trucks or eighteen-wheelers, travel across the United States logging billions of miles. On average, these vehicles consume over 50 billion gallons of fuel a year. Fuel tanks manufactured and installed on these vehicles hold over 250 gallons of fuel.

Fuel costs contribute significantly to commercial vehicles' overall operating expense. Thus, owners of commercial vehicles require an accounting of the fuel purchased. Sometimes there is a discrepancy between the amount of the fuel purchased and the amount of fuel consumed by the vehicle. Other times a discrepancy occurs between the amount of fuel purchased and the amount of fuel that enters the fuel tank. These discrepancies result in billions of dollars lost to commercial vehicle owners. Most existing attempts to monitor fuel are based on post consumption variables, and require equipment and fuel tank modifications that void factory and after factory warranties. Thus, there is a need for a fuel monitoring system that can accurately account for such discrepancies without modifying equipment or fuel tanks thereby increasing profit margins for commercial vehicle owners.

### BRIEF DESCRIPTION OF THE DRAWINGS

FIG. 1 is a cross-sectional view of a fuel monitoring system.

FIG. 2 is an illustration of a fuel tank modified to include the fuel monitoring system.

### DETAILED DESCRIPTION

The present disclosure covers a pre-consumption fuel analytic system or fuel monitoring system, generally designated as numeral 10 and hereafter referred to as system 10. System 10 improves upon traditional gas tank covers and driver accountability systems that generally only track fuel consumption but not the amount of fuel actually put into, or taken out of, a vehicle. The information obtainable from system 10 can be used by logistics teams and fleet managers to track commercial vehicle fuel usage, increase the accuracy of expenditure reporting, and prevent undetected fuel theft. Vehicle is defined herein as a piece of mechanized equipment capable of carrying or transporting something.

The drawings, illustrations and embodiments are for the purpose of describing selected versions of system 10 but are not intended to limit the scope of system 10.

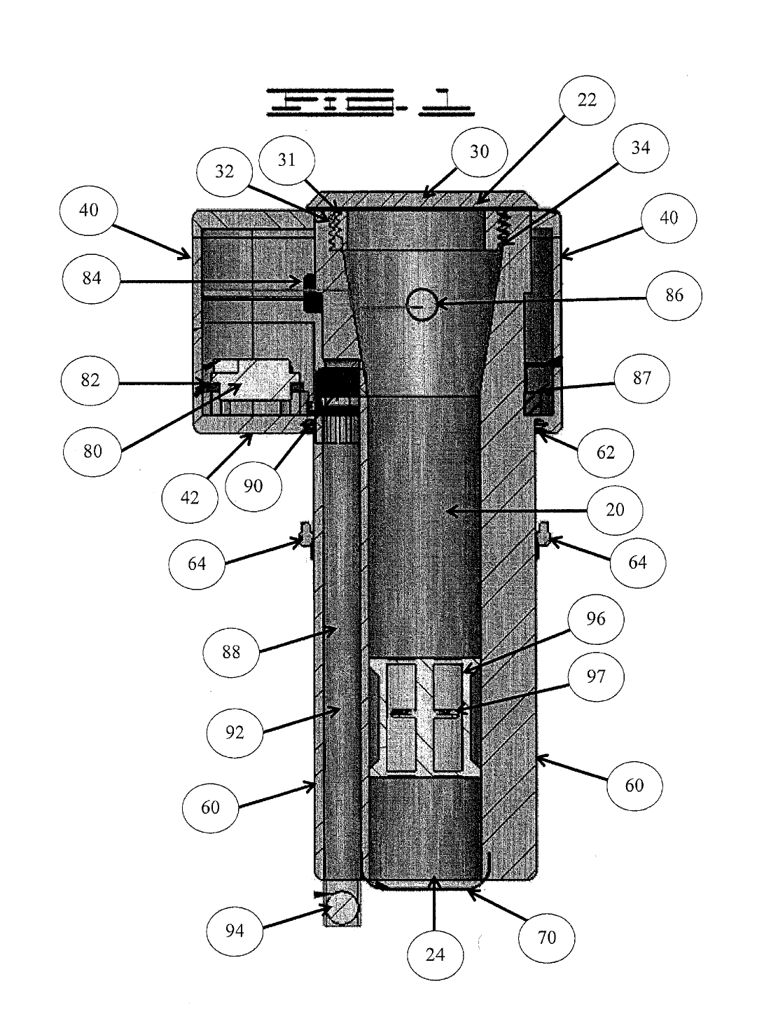

FIG. 1 is a cross-sectional view of system 10. As shown, system 10 has a cylinder neck 20 or hollow tube, a cap body 40 and a cylindrical body 60. Cap body 40 and cylindrical body 60 form a continuous unit that encloses and secures hollow tube 20. System 10 also has one or more sensors. The sensor(s) can be positioned within hollow tube 20. The sensor(s) can also be positioned outside of hollow tube 20, but within cylindrical body 60.

Generally, the sensor(s) provide(s) capabilities to measure fuel levels/fuel rates by detecting certain parameters of the fuel entering hollow tube 20 or the fuel located inside a fuel tank 100. For example, the sensor(s) may provide ultrasonic or infrared sensing for determining influx of fuel and fuel levels in the fuel tank. In some embodiments, the sensor(s) can include flow meters to provide flow rate of fuel flowing into fuel tank 100. In other embodiments, the sensor(s) can include accelerometer or gyroscope sensors for determining fuel utilization versus driving conditions/behavior. In other embodiments, the sensor(s) can be spectrometers to monitor field flow into fuel tank 100. In still other embodiments, the sensor(s) may include any other sensor capable of measuring fuel levels/fuel rates.

Hollow tube 20 has a top end 22 or first end and a bottom end 24. Hollow tube 20 is shaped such that a traditional fuel nozzle can easily slide in and out of hollow tube 20. At top end 22, a fill cap 30 connects to hollow tube 20. In one embodiment, to connect fill cap 30 to hollow tube 20, fill cap threads 31 engage hollow tube threads 32 by twisting fill cap 30 in a clockwise direction

In some embodiments, fill cap 30 has a lockset or anti-theft capability which prevents removal of fill cap 30 after fill cap 30 connects to hollow tube 20. Once connected, fill cap 20 may turn either counter-clockwise or clockwise without engaging threads 32 of hollow tube 20. In this embodiment, to remove fill cap 30, latch 34 must be released. In some embodiments, latch 34 may be released mechanically by using an external key. In other embodiments, latch 34 may be released electronically by wireless communication.

In some embodiments, system 10 also includes an anti-siphon screen 70 or grate at a bottom end 24 of hollow tube 20. Anti-siphon screen 70 prevents hoses or other siphoning devices from reaching the fuel in fuel tank 100 to siphon out the fuel. Anti-siphon screen 70 will not restrict fuel flow into the fuel tank 100.

Cap body 40 of system 10 houses, among other items, a circuit board 80, isolation standoffs 82, a tamper sensor 84, a vibration sensor 87, a connection ribbon (not shown) and a USB port (not shown). Isolation standoffs 82 secure circuit board 80 to prevent unwanted movement. Connection ribbon (not shown) provides wire connectivity between the various electrical components of system 10, such as tamper sensor 84, vibration sensor 87, USB port and other sensors and electronic devices, to circuit board 80 without having to connect directly to the circuit board 80. In other embodiments, cap body 40 can also includes a magnetic pickup port 86 to be used in connection with a metering device, such as a flow meter as further explained below.

Tamper sensor 84 or status switch senses when fill cap 30 is correctly secured to hollow tube 20. Status switch 84 also senses when fill cap 30 is incorrectly secured to hollow tube 20. Fill cap 30 is incorrectly secured to hollow tube 20 when, for example, latch 34 is released or fill cap 30 is removed or not engaged properly with threads 32.

Vibration sensor 87 senses when the vehicle is on or off by sensing vibrations. Vibration sensor 87 provides a way to track and record the time vehicles are in service to ensure that drivers comply with Hours of Service (HOS) regulations issued by the Federal Motor Carrier Safety Administration. Vibrations indicative that the vehicle is on can be vibrations caused by the vehicle motor running or vibrations caused when the vehicle is moving. The lack of such vibrations indicates that the vehicle is off.

When fill cap 30 is correctly positioned and connected to hollow tube 20, system 10 is put into a reduced activity state. In reduced activity state, only fuel level and vehicle position are recorded. When fill cap 30 is incorrectly secured to hollow tube 20, system 10 transitions into a fully active state. In fully active state, full sensing and reporting capabilities of system 10 are available. Transitions between fully active state and reduced active state are recorded and time stamped.

Circuit board 80, located within cap body 40, includes at least a power source, a microcontroller as well as globally accepted communication protocols to transmit data. The microcontroller is tasked with generating control signals for, and coordinating the operation of the electronic components found on system 10.

Globally accepted communication protocols found on the circuit board 80 include, among others, WI-FI, GSM, LTE, 3G, 4G, RF transmission, Bluetooth and GPS. Circuit board 80 may also contain other electrical components such as USB communication or WAN radio for connection over standard cellular networks. Some other components may also include serial flash/SD card for onboard data storage, status LEDs to show operation/Bluetooth pairing/battery charging etc., and other I/O components for detecting vehicle ignition, switching on/off cellular radio, and switching on/off sensors or other electrical components. The electrical components on the circuit board function at sufficiently low voltage that the risk of electrical fire is negated. System 10 communicates vehicle location and fuel information to an external database, where such information can be stored and processed.

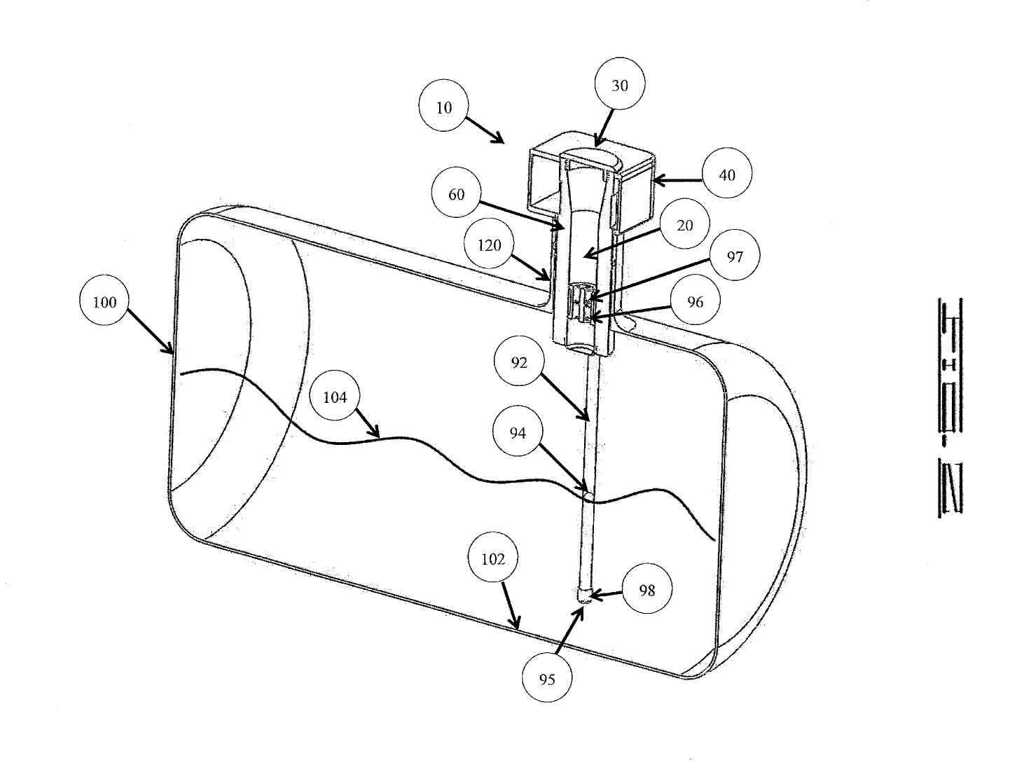

As depicted in FIG. 2, cylindrical body 60 is insertable into a standard filler tube 120 of a fuel tank 100 or fuel reservoir. Cylindrical body 60 has threads 62 near a bottom side 42 of cap body 40. Threads 62 are capable of engaging threads on filler tube 120. Cylindrical body 60 also has a locking mechanism to prevent the removal of system 10 from filler tube 120.

The locking mechanism of the cylindrical body 60 includes the use of compression locks 64. Compression locks 64 compress when cylindrical body 60 is inserted into filler tube 120. Compression locks 64 remain compressed as threads 62 engage the threads on filler tube 120. After securing cylindrical body 60 within filler tube 120, an application of downward pressure on system 10 will cause compression locks 64 to eventually extend away from cylindrical body 60. Once extended, compression locks 64 secure system 10 within filler tube 120 and serve to prevent removing system 10 from filler tube 120 of fuel tank 100. System 10 can be removed from filler tube 120 by compressing compression locks 64 mechanically or electronically. In some embodiments, compression locks 64 are compressed mechanically by using an external key (not shown). Once compression locks 64 compress, system 10 can be removed from filler tube 120 of the fuel tank 100.

As shown in FIGS. 1-2, a sensor used by system 10 includes an infrared sensor device 88. Infrared sensor device 88 is used to monitor the level of fuel in fuel tank 100. Infrared sensor device 88 contains an infrared sensor 90 and an infrared tube 92 extending from cap body 40 along the hollow tube 20. Infrared tube 92 contains an infrared float 94. Infrared sensor 90 and a portion of infrared tube 92 are enclosed by cylindrical body 60. The remaining portion of the infrared tube 92 extends below bottom end 24 of hollow tube 20. A bottom end 95 of infrared tube 92 contains an infrared tube screen 98. Infrared tube screen 98 prevents unwanted material from entering infrared tube 92 while permitting the fuel to enter the tube 92 unhindered.

When system 10 is connected to filler tube 120 of fuel tank 100, infrared tube 92 extends nearly to a bottom edge 102 of fuel tank 100. Infrared float 94 floats at a top surface 104 of the fuel. Infrared float 94 functions to provide a hard surface to ping an infrared light emitted from infrared sensor 90 back to the infrared sensor 90. Without infrared float 94, infrared light emitted from the infrared sensor 90 would penetrate fuel surface 104 and produce false readings.

To monitor the fuel level of fuel in fuel tank 100, the total capacity of fuel tank 100 must be determined. During the calibration phase of infrared sensor device 88 (one time), infrared sensor 90 sends a signal to microcontroller representative of the measured return time of the infrared light pinging off infrared float 94. The measured time is proportional to the vertical distance traveled by infrared float 94 as fuel enters fuel tank 100. In a cylindrical tank, such as fuel tank 100, the return time measurement is used to gauge the radius of fuel tank 100. At the radius of a cylindrical fuel tank, such as fuel tank 100, the rate at which infrared float 94 increases vertically is slowest. Above and below the radius of a cylindrical fuel tank, infrared float 94 increases vertically at a faster rate than at the radius. Once fuel reaches the radius of fuel tank 100, fuel tank 100 is filled to half capacity. The amount of fuel that enters fuel tank 100 after fuel tank is at half capacity can be tracked. That amount of fuel that enters into fuel tank 100 after half capacity is multiplied by two to result in the total volume or total capacity of fuel tank 100. The only information required by system 10 to calculate the total volume or total capacity is the amount of fuel pumped into fuel tank 100. Microcontroller processes the signal and calibrates system 10 to accurately measure the total capacity or total volume of fuel tank 100. Thereafter, the amount of fuel placed in the fuel tank along with the fuel level can be monitored continuously and at any given time.

In another embodiment, the system 10 measures flow rate through the use of a flow meter 96. Flow meter 96 is depicted in FIGS. 1-2 together with infrared sensor device 88 for convenience only. In some embodiments, the two sensors may be found together. In other embodiments, these sensors may be used independently from one another.

To measure flow rate into fuel tank 100, flow meter 96 is used in conjunction with magnetic pickup port 86. Turbine blades 97 of flow meter 96 begin to spin once fuel flows though hollow tube 20. Magnetic pickup port 86 produces a signal based on sensing each revolution made by turbine blades 97. Magnetic pickup port 86 sends a signal representative of each revolution to microcontroller to calculate flow rate of fuel entering fuel tank 100.

System 10 tracks all information it collects, including the amount of fuel that is put into the vehicle, the location of the vehicle, and every time that the fuel tank is accessed. This information can be wireless transmitted to a database that is accessed through a web portal or smart device application. This information can also be accessed manually via a USB cable.

In accordance with the above disclosure, several more embodiments will now be described. The present disclosure describes a fuel cap assembly or system 10 comprising a hollow tube 20 insertable into filler tube 120 of a fuel tank or fuel reservoir 100. Hollow tube 20 having a first end 22 defining an opening for receiving a fuel nozzle. Cap 30 connects to first end 22. The hollow tube has a first sensor positioned to produce a signal representative of an amount of fuel flowing through hollow tube 20. In some embodiments, the first sensor may be positioned in the hollow tube 20. In other embodiments, the first sensor is positioned in the cylindrical body 60.

The first sensor may provide ultrasonic or infrared sensing for determining influx of fuel and fuel levels in the fuel tank. In other embodiments, the first sensors may include a flow meter to provide flow rate of fuel flowing into the fuel tank. Still other first sensors may include accelerometer or gyroscope sensors for determining fuel utilization versus driving conditions/behavior. In another embodiment, the first sensor may be a spectrometer to monitor field flow into fuel tank 100. In other embodiments, the first sensor may include other sensors capable of measuring fuel levels/fuel rates.

In another embodiment, system 10 includes a microcontroller that receives the signal representative of an amount of fuel flowing through hollow tube 20 produced by the sensor. System 10 can also include a transmitter that wirelessly communicates the signal representative of an amount of fuel flowing through hollow tube 20 to a remote device. The transmitter can use any globally accepted communication protocols.

System 10 can also include a status switch 84 for indicating the connection status of cap 30 to the first end 22. System 10 is switchable between a reduced active state and a fully active state. When cap 30 is in the connected state, the system 10 is in the reduced active state, and when cap 30 is disconnected, system 10 is in the fully active state. The microcontroller switches the system 10 between the fully and reduced active states based upon the signal received from status switch 84.

In some embodiments, system 10 can further include a second sensor for producing a signal representative of the amount of fuel in the reservoir connected to the filler tube. The second sensor can include those sensors listed as first sensors or may include other sensors capable of measuring fuel levels/fuel rates.

In some embodiments, system 10 comprises a lockset for preventing the unauthorized disconnecting of the cap 30 from first end 22 of hollow tube 20. System 10 can also comprise a locking mechanism for preventing the removal of hollow tube 20 from filler tube 120.

In other embodiments, system 10 further comprising a GPS module associated with the fuel cap assembly for tracking the location of a vehicle to which it is connected. System 10 can also includes a grate 70 at bottom end 24 of hollow tube 20.

Therefore, the present disclosure is well adapted to attain the ends and advantages mentioned, as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified, and all such variations are considered within the scope and spirit of the present disclosure. Also, the terms in the claims have their plain, ordinary meaning unless otherwise explicitly and clearly defined by the patentee.

What is claimed is:

1. A fuel cap assembly comprising:
a hollow tube insertable into a filler tube of a fuel reservoir, the hollow tube having a first end defining an opening for receiving a fuel nozzle;
a cap connectable to the first end; and
a first sensor positioned to produce a signal representative of an amount of fuel flowing through the hollow tube.

2. The fuel cap assembly of claim 1, further comprising a microcontroller that receives the signal representative of an amount of fuel flowing through the hollow tube produced by the sensor.

3. The fuel cap assembly of claim 2, further comprising a transmitter that wirelessly communicates the signal representative of an amount of fuel flowing through the hollow tube to a remote device.

4. The fuel cap assembly of claim 1, further comprising a status switch for indicating the connection status of the cap to the first end.

5. The fuel cap assembly of claim 4, wherein the fuel cap assembly is switchable between a reduced active state and a fully active state.

6. The fuel cap assembly of claim 5, wherein when the cap is in the connected state the fuel cap assembly is in the reduced active state, and when disconnected the fuel cap assembly is in the fully active state.

7. The fuel cap assembly of claim 1, further comprising a second sensor for producing a signal representative of the amount of fuel in the reservoir connected to the filler tube.

8. The fuel cap assembly of claim 1, further comprising a lockset for preventing the unauthorized disconnecting of the cap from the first end of the hollow tube.

9. The fuel cap assembly of claim 8, further comprising a locking mechanism for preventing the removal of the hollow tube from the filler tube.

10. The fuel cap assembly of claim 1, further comprising a GPS module associated with the fuel cap assembly for tracking the location of a vehicle to which it is connected.

11. The fuel cap assembly of claim 10, wherein the hollow tube further comprises a grate.

12. The fuel cap assembly of claim 1, wherein the first sensor is positioned in the hollow tube.

13. The fuel cap assembly of claim 1, wherein the first sensor produces a signal representative of the amount of fuel in the reservoir connected to the filler tube

14. A fuel cap assembly comprising:
a hollow tube insertable into a filler tube of a fuel reservoir, the filler tube having a first end defining an opening for receiving a fuel nozzle;
a cap connectable to the first end; and
a status switch for indicating the connection status of the cap to the first end.

15. The fuel cap assembly of claim 14, further comprising a microcontroller that receives a signal reflecting the connection status of the cap produced by the status switch and a transmitter that wirelessly communicates the signal to a remote device.

16. The fuel cap assembly of claim 15, wherein when the cap is in the connected state the fuel cap assembly is in the reduced active state, and when disconnected the fuel cap assembly is in the fully active state, and wherein the microcontroller switches the fuel cap assembly between the fully and reduced active states based upon the signal received from the status switch.

17. The fuel cap assembly of claim 14, further comprising a sensor positioned to produce a signal representative of an amount of fuel flowing through the hollow tube.

18. The fuel cap assembly of claim 17, wherein the hollow tube further comprises a locking mechanism for preventing the removal of the hollow tube from the filler tube.

19. A fuel cap assembly comprising:
a hollow tube insertable into a filler tube of a fuel reservoir, the filler tube having a first end defining an opening for receiving a fuel nozzle;
a cap connectable to the first end; and
a locking mechanism for preventing the removal of the hollow tube from a filler tube of a fuel reservoir.

20. The fuel cap assembly of claim 19, further comprising a first sensor positioned in the hollow tube to produce a signal representative of an amount of fuel flowing through the hollow tube, and a second sensor for producing a signal representative of the amount of fuel in the fuel reservoir connected to the filler tube.

21. The fuel cap assembly of claim 20, further comprising a GPS unit for tracking the position of a vehicle to which the fuel cap assembly is connected.

22. The fuel cap assembly of claim 20, further comprising a microcontroller that receives signals produced by the GPS unit and the first and second sensors, and a transmitter that wirelessly communicates the signals from the first and second sensors and the GPS unit to a remote device.

23. The fuel cap assembly of claim 22, further comprising a status switch for indicating whether the cap is connected at the first end, wherein the transmitter sends a signal representative of the connection status to the remote device.
